(19) United States
(12) Patent Application Publication
(10) Pub. No.: US 2014/0301564 A1
(43) Pub. Date: Oct. 9, 2014

(54) System and Method for Identification and Management of Audio Streams in a Live Sound Environment

(71) Applicants: Alois William Slamecka, Atlanta, GA (US); Michael Scott Bryant, Roswell, GA (US)

(72) Inventors: Alois William Slamecka, Atlanta, GA (US); Michael Scott Bryant, Roswell, GA (US)

(21) Appl. No.: 14/215,018

(22) Filed: Mar. 16, 2014

Related U.S. Application Data
(60) Provisional application No. 61/791,464, filed on Mar. 15, 2013.

(51) Int. Cl. H04R 3/12

(52) U.S. Cl. CPC H04R 3/12
USPC 381/80

(57) ABSTRACT

Method and system for the association of sound-producing sources with network audio interfaces in a live sound environment using networked digital audio for audio stream transport. An embodiment provides for efficient setup of a live sound environment that can be replicated with the same efficiency each time it is setup. Features and actions of the exemplary embodiment allow for contextual representation of audio sources, real-time confirmation of source and interface associations, and the query of source and interface relationships; none of which were possible using prior art systems and methods.

### RELATED APPLICATION

This application claims priority to and the benefit of the prior filed co-pending and commonly owned provisional application entitled “System and Method for Identification and Management of Audio Streams in a Live Sound Environment”, which was filed with the United States Patent and Trademark Office on Mar. 15, 2013, assigned U.S. patent application Ser. No. 61/791,464, and is incorporated herein by this reference.

### FIELD OF THE INVENTION

The invention relates generally to the field of multi-channel audio signal management in a live sound environment and particularly to the systems and methods for the identification, configuration, and management of networked audio streams through contextual representations of the audio sources connected to the digital audio network.

### BACKGROUND

The technologies used to route multi-channel audio signals on a live sound stage have changed little since sound was first transported across a piece of wire. Sound signals are still routed via analog cables from the sound-producing source to an audio mixing and/or public address (PA) system. The number of cables and the density of wiring increase substantially as the number of sound sources increases. From moderate-size venues and up, separate audio mixing devices are often employed for stage mixing (for performers) and for audience mixing. The result is a collection of non-descript copper-wire cables that require the association between sound source and destination to be manually defined and documented for real-time management and future setup duplication.

The setup of audio routing in a live sound environment is a time-consuming and error-prone task. Often, sound cables are attached to a live sound mixer with each cable identified by handwriting on green tape. Mislabeling of cables or non-static labels coming loose are common occurrences that can be complex to remedy. Analog signals and the analog cables that attach to sound-producing sources have no ability to transmit information that identifies the sound source to the receiving end. At the sound mixer end (receiving end), a common practice is to label the audio channel inputs via ‘scribble strip’, a piece of tape attached below the channel volume faders where the source audio signal is manually written. Wear and tear on scribble strips causes it to be replaced on a frequent basis. Even with modern software based mixers, the source audio signals must be manually typed into virtual scribble strips.

To track audio signal connections, a manually updated log is used to record the associations between source points, connection points, and end points as there is no electronic system to automate this in an analog connectivity environment.

More recently, digital technologies are being used for connectivity and transmission of audio signals in a live sound environment based on specifications which define real-time media transport on Ethernet-based networks. Current implementations for live sound focus on aggregating analog signals onto a digital backbone for the purpose of routing large number of streams to an off-stage mixer over Ethernet. This approach relies on an analog-to-digital aggregation box and does not solve the challenge of manual identification of the source audio.

The legacy systems that dominate live sound environments and newer digital audio networking systems are limited in their ability to reduce the time-consuming process of manually identifying and documenting audio signal connections. The manual process also precludes existing systems from making rapid changes due to the lengthy cables that connect audio sources to end points. There is a need for greater visibility and context about the devices that connect into a networked digital audio environment as well as a method for customizing this information that fits within the setup workflow of a live sound environment.

It is therefore necessary to find a means to easily identify and capture a contextual description of the sound-producing source and to make this description accessible to devices that utilize digital audio networking protocols to manage networked audio stream.

### SUMMARY

Generally stated, the invention relates to a system for the association of sound-producing sources with network audio interfaces in a live sound environment using networked digital audio for audio stream transport. An exemplary embodiment provides for efficient setup of a live sound environment that can be replicated with the same efficiency each time it is setup. Features and actions of the exemplary embodiment allow for contextual representation of audio sources, real-time confirmation of source and interface associations, and the query of source and interface relationships; none of which were possible using prior art systems and methods as explained below.

Embodiments of the invention provide for the setup and management of networked audio streams in a live sound environment that address the complexity and frequency of errors in the current manual association of audio sources and endpoints.

In the exemplary embodiment, a contextual representation of a source audio device is associated with a connected network audio interface via a visual identifier. The contextual information is transmitted via network connection to an Audio Stream Management Application that matches this information to the network audio interface via a reference to the visual identifier. The Audio Stream Management Application exposes via API the contextual representation and configuration parameters of the networked audio interface to other applications on the network (e.g. mixing, recording, etc) for their individual and collective processing needs.

The invention is not limited to a specific contextual representation of the originating audio source and may include sound, image, text, or a combination of these. An exemplary embodiment provides several components that make up a unique management system for networked digital audio steams in a live sound environment. Elements of this system include a network audio interface with an ID display, a Networked Audio Interface Marking Application that captures contextual representations and associates them to a digital watermark, a Wireless Mobile Device capable of running the Networked Audio Interface Marking Application, an Audio Stream Management Application, and an application-programming interface to query the Audio Stream Management Application.

Use of the invention in exemplary embodiments allows for the immediate association of sources to interfaces as the sources are being setup. Network audio interfaces can be queried to enable exact reuse or can be assigned a new contextual relationship. This enables the system to be set up identically on multiple occasions and reconfigured quickly in the case of interface malfunction. Contextual representations can be shared across multiple network audio endpoints enabling more consistent and intuitive control of networked audio streams. And in the case of the legacy environment, the invention reduces the time spent on the documenting relationships that translate to scribble strips and eliminates the need for a manual log.

Unlike an analog environment where there is always a direct physical connection between audio source and audio mixer input, the same is not true on an Ethernet network. The physical connection of an audio source to an Ethernet switch does not create a hard-coded connection to an input on a digital mixer. The specific mapping relationships are controlled via software logic. Additionally, a networked digital audio stream can also have multiple simultaneous endpoint destinations which all benefit from a common contextual understanding of the audio signal's source, thereby creating a one to many set of relationships which must also be tracked and managed.

Proprietary and standards-based Ethernet specifications that support networked digital audio streams define device interoperability and basic network setup. This is sufficient for current systems that focus on aggregation of analog audio streams to a aggregation box as there is little physical difference in mapping sources to streams if done at the aggregation point or at a digital mixer which supports a particular Ethernet digital audio specification. The process involves little if no automation.

In the operative field of the invention, each audio source (e.g. microphone, instrument, etc.) is connected to a network audio interface located at or near the source location. The network audio interface displays a unique identifier that is provided during their initialization process on the network.

A Networked Audio Interface Marking Application associates the unique identifier with a contextual representation of the audio source in the form of predefined or free form text, image, and/or sound. Additional metadata about the source device can be captured including but is not limited to device description, stage location description, GPS location description, and audio characteristics description. This activity is done for each audio source point and can be done by multiple users of the Networked Audio Interface Marking Application simultaneously with out concern for duplication or mislabeling.

The unique identifier and associated contextual metadata are sent by the Networked Audio Interface Marking Application over the wireless network connection, as the data is captured in real-time, to an Audio Stream Mapping Database that is managed by the Audio Stream Management Application. The Audio Stream Management Application is a pro-active smart node on the digital audio network that assembles a list of active network audio interfaces by scanning the network. It then adds the detailed unique identifier and metadata to the record for each network audio interface that it receives data on from the Networked Audio Interface Marking Application. The Audio Stream Management Application monitors the real-time status of the network audio interfaces on the network and maintains a current list of interface associations. The associations are stored in static memory and are available whenever the Audio Stream Mapping Database is available on the network.

Applications or devices on the network can request the contextual and metadata information from the Audio Stream Mapping Database for active network audio interfaces via a defined API. The returned data provides intuitive information about the network audio interface that is above and beyond what is defined by the current Ethernet digital audio specifications.

The nature of the invention will be more clearly understood by reference to the following detailed description and the several views illustrated in the accompanying drawings, but the scope of the invention is not to be limited except by the claims provided below.

### BRIEF DESCRIPTION OF THE DRAWINGS

FIG. 1 is a component diagram of the system for the setup and management of networked audio streams in a live broadcast environment.

FIG. 2 is a block diagram illustrating relationships among elements in an exemplary embodiment of the invention.

FIG. 3 is a flowchart of the system process for an exemplary embodiment of the invention.

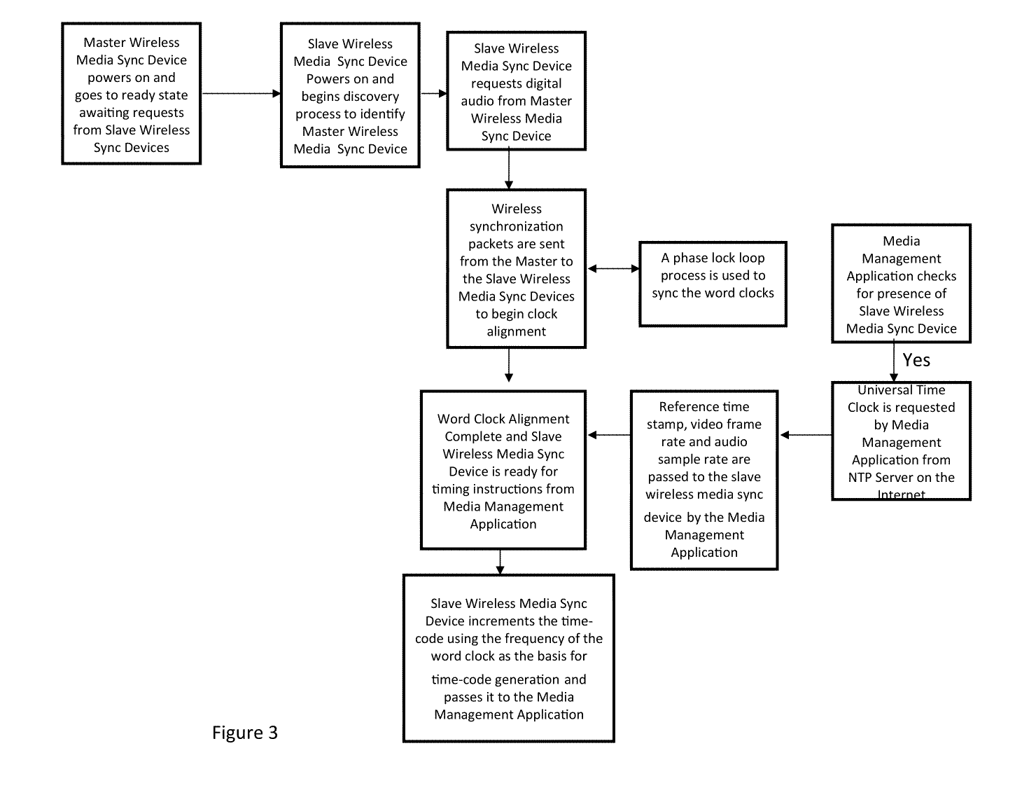

FIG. 4 is a flowchart of the system process for an exemplary embodiment of the invention.

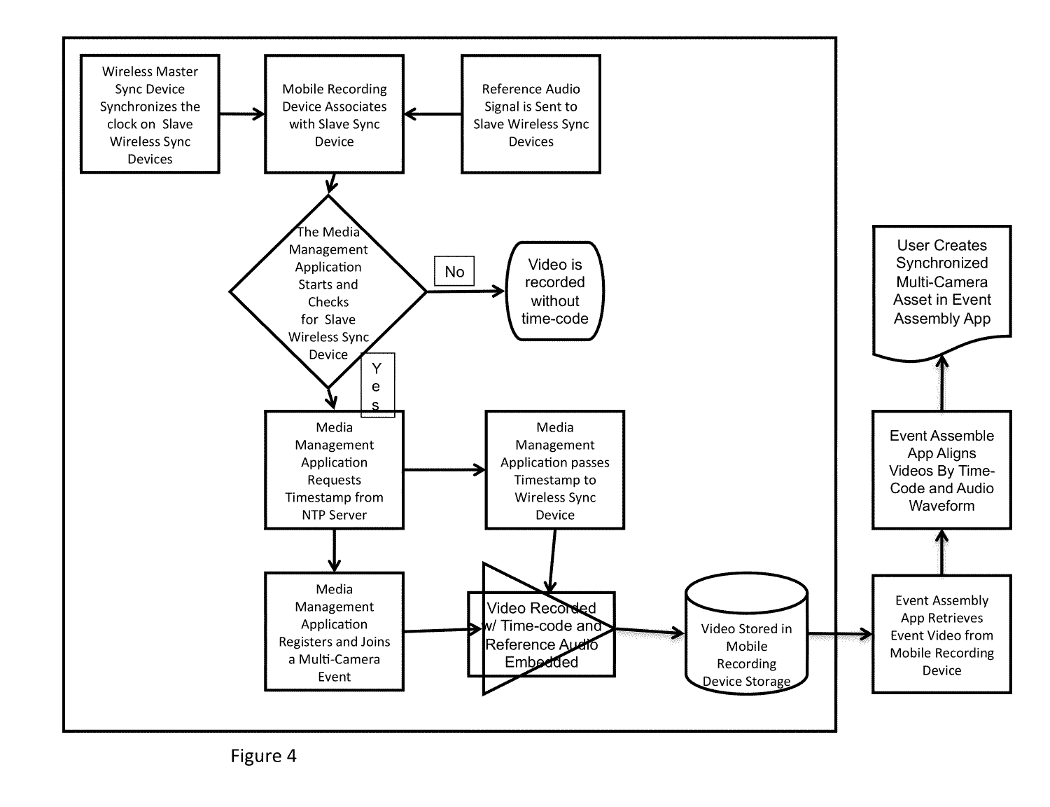

### DETAILED DESCRIPTION

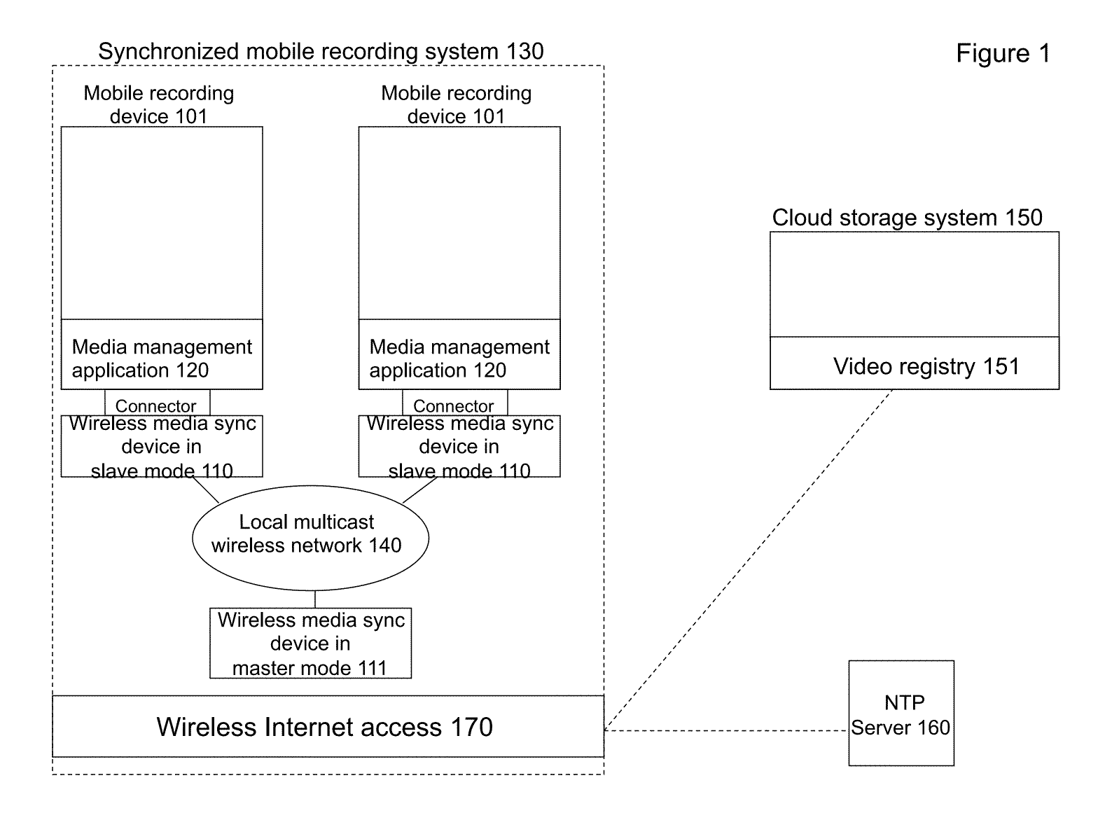

FIG. 1 shows a complete picture of the exemplary embodiment of this invention. Network audio streams in a live sound environment rely on networked audio interfaces that serve the purpose of establishing a digital audio network and convert source analog audio to digital audio for distribution on the network. When a network audio interface is connected via RJ-45 cable to an Ethernet network it begins broadcasting an identifier on the network using an industry messaging specification for digital audio network (either an open-standard specification or a commercial specification).

The Audio Stream Management Application running on a computer connected to the same network as the digital audio streams, actively listens to the network audio interface broadcasts and responds according to the protocol specification. The Audio Stream Management Application receives an identifier (e.g. MAC Address) from each network audio interface and assigns a sequential numeric ID to each identifier in the application. A record of the numeric ID and identifier association is stored in the Audio Stream Mapping Database which is maintained and updated by the Audio Stream Management Application on the computer, where the numeric ID is sent over the network back to the associated network audio interface which displays the numeric ID in an LCD window.

A Networked Audio Interface Marking Application is used to associate the audio source to the network audio interface and the network audio streams coming from the interface. The Networked Audio Interface Marking Application captures the numeric ID displayed of the network audio interface. The Networked Audio Interface Marking Application then proceeds to capture contextual information about the audio source. This includes but is not limited to pictures of the audio source, the specific device name of the source, the configuration settings of the source, the location of the source, who owns/controls the source, and whether it's a stereo or mono source. The Mobile Application stores this information locally and simultaneously transmits it wirelessly to the Audio Stream Management Application.

The Audio Stream Management Application matches the numeric ID of the networked audio interface received from the Networked Audio Interface Marking Application with the numeric ID stored in the Audio Stream Mapping Database, and updates the contextual data as part of the record in the repository. The Audio Stream Management Application sends a confirmation back to the Audio Interface Marking Application that then proceeds to capture information from the next network audio interface. The Audio Stream Mapping Database acts as a dynamic database that saves the latest data and can be queried for any of the contextual information by other applications. This would include digital mixers, software-based mixers, control applications, performer applications, and others.

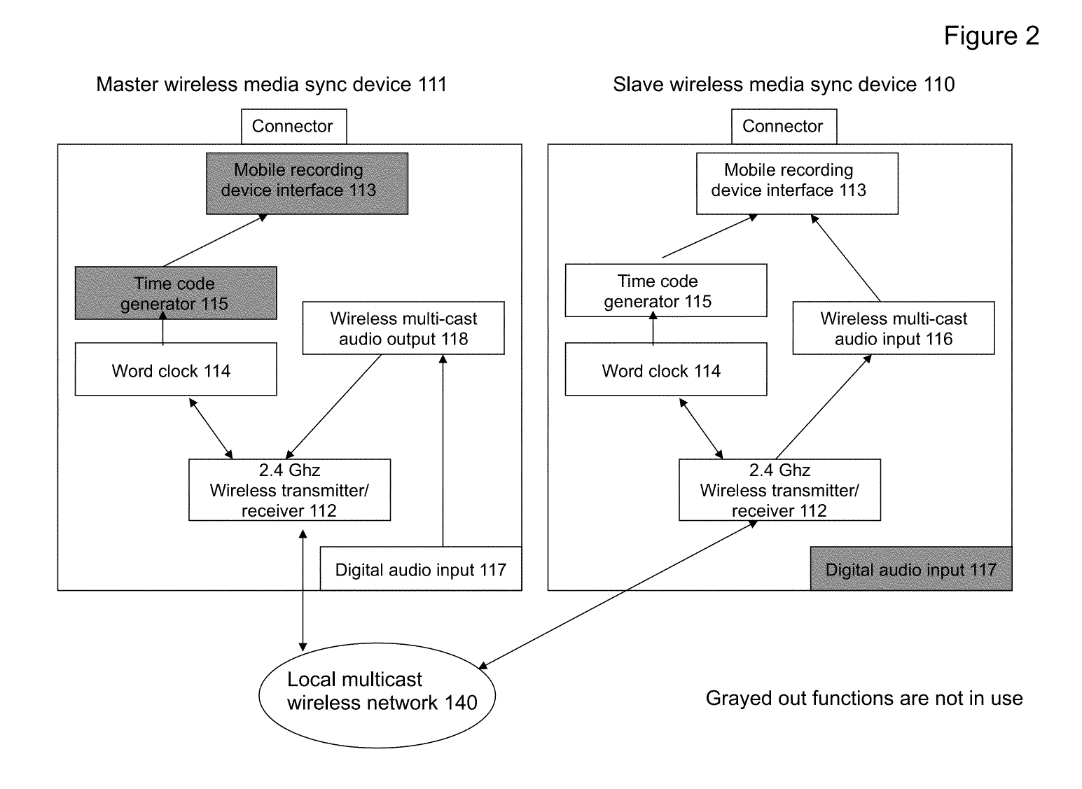

FIG. 2 shows the flowchart of the process steps in setup and management of networked audio streams described above.

Using the invention it is possible to assign contextual information to each network audio interface during the physical setup process, to store that data in a dynamic audio stream mapping database, and enable applications to access the intuitive contextual data, for the control of the network audio interfaces and the digital audio network.

A person of ordinary skill in the art understands the devices and methods with which the invention operates. To refresh this understanding, reference may be made to any of the following, which are incorporated herein by reference: Smartphone, from Wikipedia found at http://en.wikipedia.org/wiki/Smartphone as of Mar. 15, 2013; Lydon, et al., U.S. Pat. No. 8,386,677; Song, et al., United States Patent Publication No. US 2013/0067027 A1; and Yerrace et al., United States Patent Publication No. US 2013/0064386.

We claim:

1. A system for identifying, marking, tracking, and managing audio devices connected to a digital audio network, comprising:
analog audio inputs connected respectively to network audio interfaces;
a network carrying audio stream originating from the network audio interfaces;
a computer connected to the network;
an Audio Stream Management Application;
an Audio Stream Management Database;
a Wireless Mobile Device;
a Networked Audio Interface Marking Application; and
application interface (API) for the Audio Stream Management Application.

2. A method of identifying, marking, and managing the data associated with multiple audio streams, comprising:
collecting active network IDs from network audio interfaces;
assigning numeric identifier by an audio stream management application to a network audio interface;
displaying the numeric identifier by the network audio interface;
capturing metadata associated with a network audio device; and
storing the metadata in an audio stream mapping database.
